(19) United States
(12) Patent Application Publication
(10) Pub. No.: US 2026/0078876 A1
(43) Pub. Date: Mar. 19, 2026

(54) CONNECTION BASE, PLANT, AND INSTALLATION METHOD

(71) Applicant: MITSUI E&S CO., LTD., TOKYO (JP)

(72) Inventors: Kinya ICHIMURA, TOKYO (JP); Yasumitsu SATO, TOKYO (JP); Masahiro TAKAHASHI, TOKYO (JP); Junpei HIRANO, TOKYO (JP); Ayumi NAGAMACHI, TOKYO (JP)

(21) Appl. No.: 19/329,702

(22) Filed: Sep. 16, 2025

(30) Foreign Application Priority Data
Sep. 17, 2024 (JP) 2024-159857

(51) Int. Cl. F17C 9/00; F17C 13/12

(52) U.S. Cl. CPC F17C 9/00; F17C 13/12; F17C 2205/037; F17C 2221/012; F17C 2260/04; F17C 2265/06

(57) ABSTRACT

Provided are a connection base, a plant, and an installation method that enable easy installation and replacement of container modules. A connection base 3 to be fixed to a mounting surface and allow a container module 2 to be installed on an upper surface 3a includes a connecting mechanism 4 to be connected to an instrument 2a installed inside the container module 2 and a pipe 5 arranged at a position below the upper surface 3a, one end of the pipe 5 connected to the connecting mechanism 4, and a fixing mechanism 6 to fix the container module 2. After the container module 2 is placed on the connection base 3, a container-side connecting mechanism 2b of the container module 2 is connected to the connecting mechanism 4 and the container module 2 is fixed to the connection base 3 by the fixing mechanism 6.

### TECHNICAL FIELD

The present invention relates to a connection base on which a container module is installed, a plant including a container module and a connection base, and a method of installing a container module on a connection base, and more specifically relates to a connection base, a plant, and an installation method that enable easy installation and replacement of a container module.

### BACKGROUND ART

Various power generation systems using container modules have been proposed (for example, see Japanese Patent Application Kokai Publication No. 2017-010646). A power generation system described in Japanese Patent Application Kokai Publication No. 2017-010646 generates hydrogen and electric power by using a combination of multiple container modules in which a hydrogen generator, a hydrogen tank, and a fuel cell are installed.

In order to transfer a fluid or the like between a container module and an external facility, a pipe of the external facility and a pipe of the container module need to be aligned with each other with high precision. In addition, in the case where multiple container modules are installed, pipes connecting the container modules need to be aligned with each other with high precision. For this reason, it takes a lot of time and effort to install the container modules on a mounting surface such as a ground surface. Furthermore, in some cases, there is no instruction about the work of fixing the placed container modules to the mounting surface such as the ground surface, such as laying anchor bolts, and the fixing work requires a long time.

In the case where a certain container module needs to be replaced due to a malfunction or any other reason, the pipes connecting the container modules have to be disconnected and reconnected. In the case where the pipes are for hydrogen gas, work such as nitrogen purge is required, making it difficult to replace the container module.

There is a problem of a tilt of a container module installed on a sloping ground surface. For example, in the case where a reciprocating compressor, a diesel engine, or the like is installed in a container module, the tilt of the container module causes a problem of the occurrence of uneven wear of a piston ring or the like, thereby shortening the life of the container module.

### SUMMARY OF INVENTION

### Technical Problem

The present invention has been made in view of the above problem, and has an object to provide a connection base, a plant, and an installation method that enable easy installation and replacement of container modules.

### Solution to Problem

A connection base for achieving the above object is configured to be fixed to a mounting surface and allow a container module to be installed on an upper surface of the connection base, and includes a connecting mechanism configured to be connected to an instrument installed inside the container module; a pipe arranged at a position below the upper surface, one end of the pipe connected to the connecting mechanism; and a fixing mechanism configured to fix the container module.

A plant for achieving the above object includes a container module in which an instrument is installed, and a connection base fixed to a mounting surface and having the container module installed on an upper surface of the connection base. The connection base includes: a connecting mechanism configured to be connected to the instrument installed inside the container module; a pipe arranged at a position below the upper surface, one end of the pipe connected to the connecting mechanism; and a fixing mechanism configured to fix the container module.

An installation method for achieving the above object is a method of installing a container module in which an instrument is installed in a plant, the plant including the container module and a connection base fixed to a mounting surface and configured to allow the container module to be installed on an upper surface of the connection base, the connection base including, in advance, a connecting mechanism to be connected to the instrument installed inside the container module, a pipe arranged at a position below the upper surface, one end of the pipe connected to the connecting mechanism, and a fixing mechanism configured to fix the container module, the method including a placing step of placing the container module on the connection base; a connecting step of connecting the container module to the connecting mechanism; and a fixing step of fixing the container module to the connection base with the fixing mechanism.

### Advantageous Effect of Invention

According to the present invention, the connection of pipes of a container module can be completed by just installing the container module on the connection base. In addition, the container module can get ready to be removed from the connection base by just being disconnected from the connecting mechanism and unfixed from the fixing mechanism. This is advantageous to easily install and replace the container module.

### BRIEF DESCRIPTION OF THE DRAWINGS

FIG. 1 is a perspective view illustrating a container module and a connection base.

FIG. 2 is an explanatory diagram illustrating the connection base in plan view.

FIG. 3 is an explanatory diagram illustrating a modification of FIG. 2.

FIG. 4 is an explanatory diagram illustrating a modification of FIG. 3.

FIG. 5 is an explanatory diagram illustrating a safety mechanism of the connection base.

FIG. 6 is an explanatory diagram illustrating a plant in plan view.

FIG. 7 is an explanatory diagram illustrating a modification of FIG. 6.

### DESCRIPTION OF EMBODIMENTS

Hereinafter, a connection base, a plant, and an installation method will be described based on an embodiment illustrated in the drawings. In the drawings, a short-side direction of the connection base is indicated by arrow x, a long-side direction crossing perpendicular to the short-side direction x is indicated by arrow y, and a vertical direction orthogonal to the short-side direction x and the long-side direction y is indicated by arrow z.

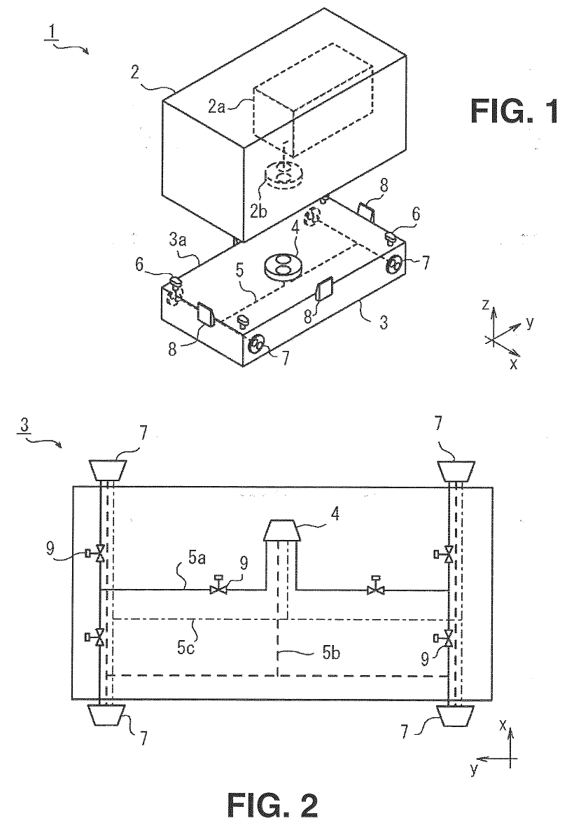

As illustrated in FIGS. 1 and 2, a plant 1 includes a container module 2 in which an instrument 2a is installed, and a connection base 3 fixed to a mounting surface such as a ground surface, and configured to allow the container module 2 to be installed on an upper surface 3a of the connection base 3. FIG. 1 illustrates the instrument 2a in dashed lines for the sake of explanation.

In the case where the plant 1 constitutes, for example, a hydrogen station, the instruments 2a includes formed of, for example, a tank for storing hydrogen fuel. The tank stores, for example, liquid hydrogen or hydrogen gas as the hydrogen fuel. In addition, the instruments 2a include a vaporizer for gasifying the liquid hydrogen, a compressor for compressing the hydrogen gas, and a dispenser for supplying the hydrogen gas to outside such as vehicles. In one container module 2, one of more of the above instruments 2a are installed.

The instruments 2a are not limited to the above. The instruments 2a are changed as appropriate according the purpose of the plant 1. For example, in the case where the plant 1 constitutes a power generation plant, the instruments 2a includes a power generator in combination with an internal combustion engine, and a tank that stores fuel appropriate for this internal combustion engine. The plant 1 may constitute another chemical plant such, for example, as an ammonia production plant.

The container module 2 includes, for example, a 20 ft container for marine transport. The size of the container module 2 is not limited to the size of the 20 ft container. For example, the container module 2 may include a container in another size such as a 40 ft container or a 45 ft container.

The connection base 3 is fixed in advance to a mounting surface such as a ground surface. The connection base 3 is desirably fixed to the mounting surface with the upper surface 3a horizontal. The connection base 3 is large enough to allow the container module 2 to be installed on the upper surface 3a. In the present embodiment, the connection base 3 is large enough to allow, for example, a 20 ft container to be installed.

The connection base 3 includes a connecting mechanism 4 to be connected to the instrument 2a installed inside the container module 2, pipes 5 arranged at a position below the upper surface 3a, one ends of the pipes 5 connected to the connecting mechanism 4, and fixing mechanisms 6 configured to fix the container module 2.

The connecting mechanism 4 includes, for example, a multi-coupling that enables connection and disconnection of multiple types of pipes 5 at once. The connecting mechanism 4 is not limited to this, and may have a structure that enables individual connection and disconnection of each of the pipes 5. In the present embodiment, one connecting mechanism 4 is provided to the connection base 3. The connecting mechanism 4 is placed on the upper surface 3a of the connection base 3. A container-side connecting mechanism 2b conforming to the connecting mechanism 4 is placed on a lower surface of the container module 2. FIG. 1 illustrates the container-side connecting mechanism 2b in dashed lines for the sake of explanation. The instrument 2a and the connecting mechanism 4 are indirectly connected to each other via piping connecting the instrument 2a and the container-side connecting mechanism 2b and via the container-side connecting mechanism 2b. Instead of the structure where the container module 2 includes the container-side connecting mechanism 2b, the connecting mechanism 4 may be extended to the inside of the container module 2. In this case, the instrument 2a and the connecting mechanism 4 are directly connected to each other.

As illustrated in FIG. 2, the pipes 5 may include not only a pipe (outward pipe) 5a for transporting a fluid such as hydrogen fuel, but also a power cable 5b for supplying electric power to the instrument 2a, a signal line 5c for controlling the instrument 2a, and so on. In this case, the connecting mechanism 4 may enable connection and disconnection of the outward pipe 5a, the power cable 5b, and the signal line 5c with a multi-coupling or may enable individual connection and disconnection of each of the pipes 5. There may be two or more outward pipes 5a for fluid. FIG. 1 illustrates the pipes 5 in dashed lines for the sake of explanation. FIG. 2 illustrates the power cable 5b in dashed lines and the signal line 5c in dashed-dotted lines For the sake of explanation. The types and number of the pipes 5 are changed as appropriate according to needs of the container module 2 to be installed.

One end of each pipe 5 is connected to the connecting mechanism 4 and the other end of the pipe 5 is connected to an external connecting mechanism 7. The connection base 3 can be supplied with, for example, electric power, water, and so on from the outside via the external connecting mechanisms 7. In addition, the connection base 3 can supply, for example, the hydrogen fuel, the electric power, and so on to the outside via the external connecting mechanisms 7.

As illustrated in FIG. 1, the fixing mechanisms 6 have a function to fix the container module 2 to the connection base 3. Each of the fixing mechanisms 6 is formed of a twist lock with which a container for marine transport is fixed to and lifted up by a crane or the like. In the present embodiment, the twist lock is turned by 90° about the vertical direction z set as a central axis, thereby switching between fixing and unfixing of the container module 2.

The fixing mechanism 6 is not limited to the twist lock. The fixing mechanism 6 may have any structure capable of fixing the container module 2 to the connection base 3. For example, the fixing mechanism 6 may be formed of a fixing bracket that is arranged between vertically-stacked containers for marine transport and is capable of connecting the upper and lower containers to each other. This fixing bracket is inserted into oval holes formed in both of the connection base 3 and the container module 2 and thereby fixed to both of the connection base 3 and the container module 2. The fixing mechanism 6 may be formed of a lashing or the like that fastens the container module 2 to the connection base 3.

Next, an installation method of installing the container module 2 on the connection base 3 will be described. The connection base 3 is fixed to the mounting surface in advance. In this state, the external connecting mechanisms 7 are connected to an external power source, water source, and so on in advance. First, the container module 2 is placed on the connection base 3 (hereinafter also referred to as a placing step S10). After that, the container module 2 is connected to the connecting mechanism 4 (hereinafter also referred to as a connecting step S20). Then, the container module 2 is fixed to the connection base 3 by the fixing mechanisms 6 (hereinafter also referred to as a fixing step S30).

Specifically, the container module 2 is transported and placed on the upper surface 3a of the connection base 3 by a crane, a reach stacker, or the like (the placing step S10). In the case where the connecting mechanism 4 includes a multi-coupling, the container-side connecting mechanism 2b and the connecting mechanism 4 may be automatically connected to each other (the connecting step S20) when the container module 2 is placed. Instead, the connecting mechanism 4 may be connected to the container module 2 by an operation of a lever or the like provided to the connection base 3. In the case where the fixing mechanisms 6 are formed of twist locks, the container module 2 is fixed to the connection base 3 by turning the twist locks (the

### Fixing Step S30).

The installation method is not limited to that where the fixing step S30 is executed after the connecting step S20. The connecting step S20 may be executed after the fixing step S30, or the connecting step S20 and the fixing step S30 may be executed at the same time.

In the case where the container module 2 needs to be replaced due to a malfunction or the like, the container module 2 is removed from the connection base 3 according to a procedure reverse to the above one. Specifically, after the connecting mechanism 4 is disconnected and the container module 2 is unfixed from the twist locks, the container module 2 is lifted up from the connection base 3 by the crane or the like.

This structure makes it easy to install the container module 2 on the mounting surface. In the process of placing the container module 2 on the connection base 3, the position of the container module 2 relative to the mounting surface is determined with high precision. In addition, since the pipes 5 are fixed to the connection base 3 beforehand, the alignment of the container module 2 with external pipes and the like are not needed. It is advantageous to make it easy to install the container module 2.

This structure also makes it easy to replace the container module 2. After the container module 2 is disconnected from the connecting mechanism 4 and is unfixed from the fixing mechanisms 6, the container module 2 gets ready to be removed from the connection base 3. It is advantageous to make it easy to replace the container module 2. Moreover, since the fixing brackets (twist locks) for containers for marine transport are widely available, the fixing mechanisms 6 can be formed inexpensively by using these fixing brackets.

This structure allows the container module 2 to have a longer life. The connection base 3 is beforehand fixed to the mounting surface with the upper surface 3a horizontal, so that the container module 2 placed on the connection base 3 can be easily kept horizontal. This makes it possible to avoid a problem of the occurrence of uneven wear of a piston ring or the like in the instrument 2a. Therefore, this structure is advantageous to achieve a longer life of the container module 2.

Even if the connection base 3 is used alone without the container module 2, the same effect as above can be obtained. In other words, in addition to the plant 1 including the container module 2 and the connection base 3, the connection base 3 alone can produce the above effect.

The connecting mechanism 4 is not limited to the structure in which the connecting mechanism 4 is formed on the upper surface 3a of the connection base 3. The connecting mechanism 4 may be formed at a position on a side of the connection base 3 and above the upper surface 3a of the connection base 3. In this case, the container-side connecting mechanism 2b formed on a side surface of the container module 2 is configured to be connectable to the connecting mechanism 4.

As illustrated in FIG. 1, the connection base 3 may include guide mechanisms 8 that are arranged above the upper surface 3a of the connection base 3 and configured to guide the container module 2 to a predetermined position in the horizontal directions x and y. Each guide mechanism 8 has an inclined surface extending obliquely toward an inner side and configured to come into contact with a bottom surface of the container module 2. Only at least a part of the guide mechanism 8 has to be located above the upper surface 3a.

This structure makes it easy to install and replace the container module 2. Since the guide mechanisms 8 can guide the container module 2 to the predetermined position in the horizontal directions x and y, the connecting mechanism 4 and the container-side connecting mechanism 2b are easily aligned with each other. It is advantageous to make it easy to install and replace the container module 2.

The guide mechanisms 8 are desirably arranged on both sides in the long-side direction y and both sides in the short-side direction x of the connection base 3. In the case where the container module 2 is lifted down while being roughly concentrically aligned with the connection base 3, the container module 2 comes into contact with the guide mechanisms 8 and is guided to the correct position in the horizontal directions x and y.

In the case where the connection base 3 includes an external connecting mechanism 7 connected to the other ends of the pipes 5 and configured to allow the connection base 3 to be connected to another connection base 3, the connecting mechanism 4 is connected to the one ends of the pipes 5 and the external connecting mechanism 7 is connected to the other ends of the pipes 5. The external connecting mechanisms 7 are capable of connecting the connection bases 3 to each other. The external connecting mechanism 7 is not an essential constituent element of the connection base 3. The pipes 5 may be extended to the outside of the connection base 3 and be directly connected to a power source or a water source without the external connecting mechanism 7 interposed in between.

Multiple connection bases 3 may be installed on the mounting surface in advance and connected to each other via the external connecting mechanisms 7. The container modules 2 are installed on the respective connection base 3, so that the container modules 2 are indirectly connected to each other. For example, a fluid or the like subjected to a certain treatment in one of the container modules 2 can be subjected to a different treatment in the next container module 2.

The structure including the external connecting mechanisms 7 makes it easy to install the container modules 2. The pipes 5 of multiple connection bases 3 are connected to each other via the external connecting mechanisms 7 in advance. Multiple container modules 2 are installed on the connection bases 3, and thereby are enabled to transfer a fluid, supply electric power, and exchange signals between them. There is no need to perform the work of aligning, disconnecting, and reconnecting the pipes 5 between the container modules 2.

With this structure, the plant 1 can be expanded easily. The plant 1 can be expanded by increasing the number of connection bases 3 via the external connecting mechanisms 7 and resultantly increasing the number of container modules 2.

The number of external connecting mechanisms 7 provided to one connection base 3 may be one, two, or more. In the case where the connection base 3 includes multiple external connecting mechanisms 7, control valves 9 may be provided to the outward pipe 5a for fluid, thereby controlling fluid channels. In addition, the connection base 3 may be configured to receive a fluid, electric power, and so on via one external connecting mechanism 7, and supply the fluid, the electric power, and so on to the outside via another external connecting mechanism 7. Instead, the connection base 3 may be provided with multiple external connecting mechanisms 7 via which the connection base 3 supplies the fluid and so on to the outside.

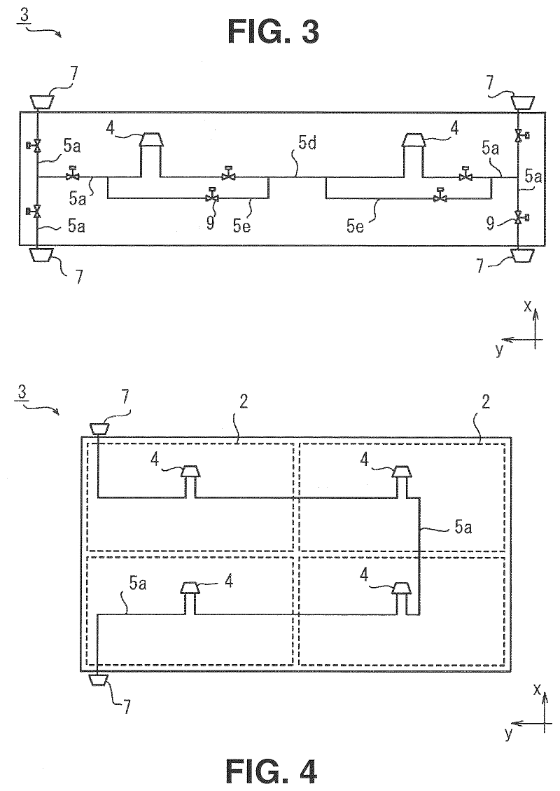

As illustrated in FIG. 3, the connection base 3 may be large enough to allow multiple container modules 2 to be installed thereon, and include multiple connecting mechanisms 4 connectable to the respective container modules 2. In this structure, the pipes 5 include outward pipes 5a each connecting the connecting mechanism 4 to the external connecting mechanisms 7 and an intermediate pipe 5d connecting the connecting mechanisms 4 to each other. All the outward pipes 5a and the intermediate pipe 5d are formed of pipes for fluid.

In the present embodiment, the connection base 3 is large enough to allow two container modules 2 to be installed in the long-side direction y. For example, the connection base 3 may be configured to have a 40 ft size, and allow two 20 ft container modules 2 to be installed thereon. The connection base 3 may have a structure that allows three or more container modules 2 to be installed thereon. Here, the connection base 3 includes fixing mechanisms 6 for fixing each of the container modules 2.

In the case where two container module 2 are installed on the connection base 3, the two container modules 2 are connected to each other via the pipes 5 and the like. For example, a fluid or the like treated in one of the container modules 2 can be treated in the other container module 2.

With this structure, it is possible to install multiple container modules 2 having different functions on one connection base 3. The functions of the plant 1 can be easily changed by changing a combination of container modules 2.

As illustrated in FIG. 3, the connection base 3 may include bypass pipes 5e each bypassing a particular connecting mechanism 4. The bypass pipe 5e allows the outward pipe 5a and the intermediate pipe 5d to communicate with each other, thereby bypassing the connecting mechanism 4. In this case, the fluid channel is controlled by opening and closing of the control valves 9. The connection base 3 may include a bypass pipe 5e bypassing multiple connecting mechanisms 4 at once.

As illustrated in FIG. 4, the connection base 3 may be large enough to allow multiple container modules 2 to be installed in the short-side direction x. FIG. 4 illustrates the container modules 2 in dashed lines for the sake of explanation. In the present embodiment, the connection base 3 has a structure that allows totally four container modules, two in the short-side direction x and two in the long-side direction y, to be installed thereon.

In the present embodiment, in FIG. 4, a fluid supplied from the left upper external connecting mechanism 7 is transferred from the left upper container module 2 to the right upper container module 2, the right lower container module 2, and the left lower container module 2 in this order while being treated in each of the container modules 2, and is discharged from the left lower external connecting mechanism 7 to the outside.

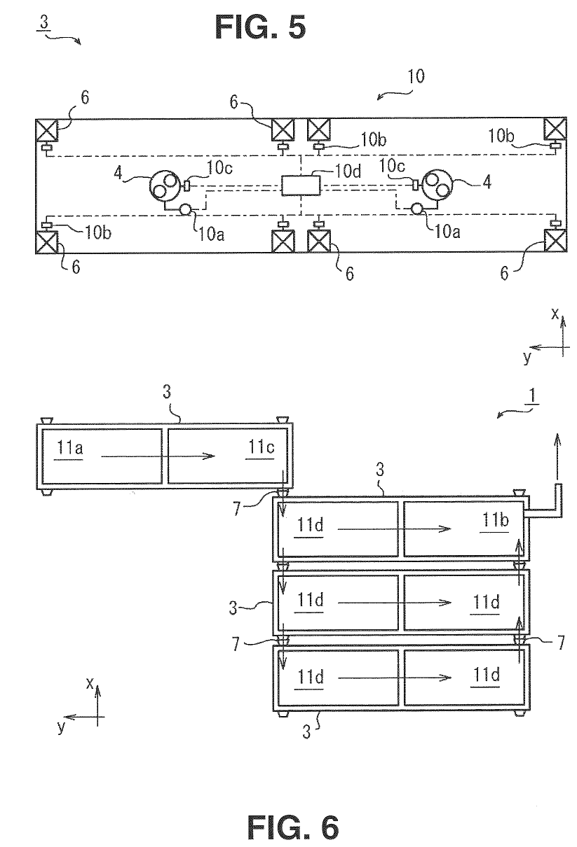

As illustrated in FIG. 5, the connection base 3 may include a safety mechanism 10. FIG. 5 illustrates only members related to the safety mechanism 10 among the members provided to the connection base 3 illustrated in FIG. 3. The safety mechanism 10 includes determination units 10a each configured to determine whether the container module 2 and the connecting mechanism 4 are connected to each other, and unfixing units 10b each configured to allow the container module 2 to be unfixed from the fixing mechanism 6. The safety mechanism 10 may also include pipe disconnection units 10c each configured to control the connection and disconnection of the connecting mechanism 4.

The safety mechanism 10 is configured based on, for example, electric control. In this case, the safety mechanism 10 includes a control unit 10d configured to control the determination units 10a and the unfixing units 10b. Each determination unit 10a is formed of, for example, a sensor to determine whether the signal lines of the connecting mechanism 4 and the container-side connecting mechanism 2b are connected to each other. The determination unit 10a determines a connected state if a connection signal can be received from the container module 2 and a disconnected state if the connection signal cannot be received. The safety mechanism 10 including the determination units 10a, the unfixing units 10b, and the control unit 10d is formed of, for example, a known PC or programmable logic controller (PLC).

In the case where the connection base 3 includes levers each operated to connect the connecting mechanism 4 and the container-side connecting mechanism 2b to each other, each determination unit 10a may be formed of a proximity sensor to detect the position of the lever. The sensor determines whether the lever is tilted to a connection side or to a disconnection side. In this case, each of the pipe disconnection units 10c is formed of the above lever.

The determination unit 10a may be formed of a pressure sensor to detect a pressure in the connecting mechanism 4. The determination unit 10a determines the connected state if the pressure of a fluid flowing in the connecting mechanism 4 is detected. The determination unit 10a may be formed of any of the above sensors or a combination of multiple sensors.

The control unit 10d receives a signal from each of the determination units 10a and recognizes whether the connecting mechanism 4 is in the connected state or the disconnected state. In the case where the connecting mechanism 4 is in the disconnected state, the control unit 10d transmits to the unfixing unit 10b a signal indicating that the container module 2 is ready to be unfixed. In the case where the connecting mechanism 4 is in the connected state, the control unit 10d may transmit a signal indicating the connected state to the unfixing unit 10b.

The unfixing unit 10b receives a signal indicating the connected state or the disconnected state from the control unit 10d, and unfixes the container module 2 from the fixing mechanism 6 based on this signal. The unfixing unit 10b is formed of, for example, a motor to turn the twist lock (fixing mechanism 6). Unless the signal indicating the disconnected state is received, the unfixing unit 10b can prohibit the twist lock constituting the fixing mechanism 6 from turning. FIG. 5 illustrates the signal lines in dashed-dotted lines for the sake of explanation. The unfixing unit 10b may be formed of a switch provided to a signal line of a motor to operate the fixing mechanism 6. The unfixing unit 10b may be configured to block a signal for controlling the motor unless the signal indicating the disconnected state is received. Even if a signal for causing the motor of the fixing mechanism 6 to unfix the container module 2 is transmitted to the motor, the unfixing unit 10b blocks the signal. The fixed state by the fixing mechanism 6 is maintained.

The safety mechanism 10 may be configured based on mechanical control. For example, the determination unit 10a may be configured to mechanically detect the position of a lever (the pipe disconnection unit 10c) to be operated to connect the connecting mechanism 4, and, unless the lever is located at the disconnected position, disable levers for causing the fixing mechanisms 6 to unfix the container module 2 from being operated. In this case, the unfixing units 10b are formed of the levers for operating the fixing mechanisms 6.

With this structure, when the connecting mechanism 4 is in the connected state, the fixing mechanisms 6 are prohibited from turning into the unfixing state, which improves the safety. When the connecting mechanism 4 is in the connected state, even if a crane or the like tries to lift the container module 2 up, the container module 2 is fixed to the connection base 3 and therefore cannot be lifted up. This can prevent an accident in which, in the work of removing the container module 2 from the connection base 3, the connecting mechanism 4 mistakenly left connected is damaged.

In the case where multiple connecting mechanisms 4 and fixing mechanisms 6 are provided to one connection base 3, each connecting mechanism 4 and the corresponding fixing mechanisms 6 cooperate with each other. In FIG. 5, the four fixing mechanisms 6 on the left side are controlled depending on whether the connecting mechanism 4 on the left side is connected or not. Similarly, the four fixing mechanisms 6 on the right side are controlled depending on whether the connecting mechanism 4 on the right side is connected or not.

As illustrated in FIG. 6, the plant 1 may include a combination of multiple connection bases 3 and multiple types of container modules 2. The container modules 2 may include a tank module 11a equipped with a tank for storing hydrogen fuel and a dispenser module 11b equipped with a dispenser for supplying the hydrogen fuel to external vehicles and so on. This plant 1 serves as a hydrogen station for supplying the hydrogen fuel to vehicles and so on.

Specifically, as illustrated in FIG. 6, the multiple connection bases 3 are connected to each other via external connecting mechanisms 7. On the first connection base 3, the tank module 11a for storing the hydrogen fuel and a vaporization module 11c equipped with a vaporizer for gasifying the liquid hydrogen are installed. On the second connection base 3, a compression module 11d equipped with a compressor for compressing the hydrogen fuel made of hydrogen gas, and the dispenser module 11b are installed. On each of the third and fourth connection bases 3, two compression modules 11d are installed. In FIG. 6, transfer directions of the hydrogen fuel as a fluid are illuminated by arrows for the sake of explanation.

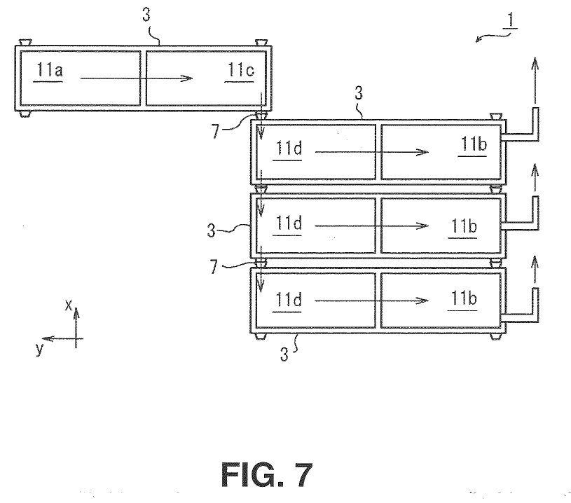

In the plant 1 in the present embodiment, the liquid hydrogen is supplied from the tank module 11a to the vaporization module 11c. In the vaporization module 11c, the liquid hydrogen is changed to the hydrogen gas. The hydrogen gas is transferred to the compression module 11d and compressed to a high pressure. The hydrogen gas after passing through the compression module 11d is supplied to a vehicle or the like via the dispenser module 11b. The dispenser module 11b is supplied with the hydrogen gas compressed in the one compression module 11d and the hydrogen gas compressed in the two compression modules 11d. Including the multiple compression modules 11d, the plant 1 is capable of compressing the hydrogen gas to multiple levels of high pressures. In addition, as illustrated in FIG. 7, the plant 1 may be configured such that each of dispenser modules 11b supplies a vehicle and so on with the hydrogen gas compressed in one compression module 11d. In this case, the hydrogen gas may or may not be transferred between the connection bases 3 on which the dispenser modules 11b are installed.

According to this structure, the work of connecting the pipes 5 of the container modules 2 to each other and others can be completed only by installing the container modules 2 on the multiple connection bases 3. Thus, it is easier to construct the plant 1 than in the conventional technique of connecting the pipes 5 of multiple container modules 2 to each other.

With this structure, the plant 1 can be supplied with the fuel only by replacing the tank module 11a. This replacement of the tank module 11a can be completed within approximately the same amount of time as the container loading and unloading work. Thus, the fuel supply to the plant 1 can be performed within a short period of time. Furthermore, in the case where a malfunction occurs in the compressor or the like, the processing in the plant 1 can be restarted with replacement of the compression module 11d. This is advantageous for shortening the repair period in the plant 1.

With this structure, the plant 1 can be easily expanded by adding connection bases 3 and container modules 2. For example, if there is a need to supply the fuel to multiple vehicles, one or more dispenser modules 11b may be added.

In the case where hydrogen gas is stored as the hydrogen fuel in the tank module 11a, the hydrogen gas may be compressed in the compression module 11d without needing the vaporization module 11c, and supplied to a vehicle or the like from the dispenser module 11b. In this case, two tank modules 11a may be installed on the first connection base 3, and the bypass pipe 5e illustrated in FIG. 3 may be used. The hydrogen gas can be supplied to the second connection base 3 from both of the two tank modules 11a.

### REFERENCE SIGNS LIST

1 plant
2 container module
2a instrument
2b container-side connecting mechanism
3 connection base
3a upper surface
4 connecting mechanism
5 pipe
5a outward pipe
5b power cable
5c signal line
5d intermediate pipe
5e bypass pipe
6 fixing mechanism
7 external connecting mechanism
8 guide mechanism
9 control valve
10 safety mechanism
10a determination unit
10b unfixing unit
10c pipe disconnection unit
10d control unit
11a tank module
11b dispenser module
11c vaporization module
11d compression modules
x short-side direction
y long-side direction
z vertical direction
S10 placing step
S20 connecting step
S30 fixing step

What is claimed is

1. A connection base which is configured to be fixed to a mounting surface and allow a container module to be installed on an upper surface of the connection base, comprising:
a connecting mechanism configured to be connected to an instrument installed inside the container module;
a pipe arranged at a position below the upper surface, one end of the pipe connected to the connecting mechanism; and
a fixing mechanism configured to fix the container module.

2. The connection base according to claim 1, further comprising an external connecting mechanism connected to the other end of the pipe and configured to allow the connection base to be connected to another connection base.

3. The connection base according to claim 2, wherein
the connection base is large enough to allow a plurality of the container modules to be installed, and includes a plurality of the connecting mechanisms each configured to be connectable with one of the container modules, and
the pipe includes an outward pipe connecting each of the connecting mechanisms and the external connecting mechanism to each other, and an intermediate pipe connecting the connecting mechanisms to each other.

4. The connection base according to claim 1, further comprising a safety mechanism, wherein
the safety mechanism includes a determination unit configured to determine whether the container module is connected to the connecting mechanism, and an unfixing unit configured to allow the container module to be unfixed from the fixing mechanism in a case where the connecting mechanism is in a disconnected state.

5. The connection base according to claim 2, further comprising a safety mechanism, wherein
the safety mechanism includes a determination unit configured to determine whether the container module is connected to the connecting mechanism, and an unfixing unit configured to allow the container module to be unfixed from the fixing mechanism in a case where the connecting mechanism is in a disconnected state.

6. The connection base according to claim 3, further comprising a safety mechanism, wherein
the safety mechanism includes a determination unit configured to determine whether the container module is connected to the connecting mechanism, and an unfixing unit configured to allow the container module to be unfixed from the fixing mechanism in a case where the connecting mechanism is in a disconnected state.

7. The connection base according to claim 1, comprising a guide mechanism arranged above the upper surface of the connection base and configured to guide the container module to a predetermined position in a horizontal direction.

8. A plant comprising:
a container module in which an instrument is installed in the plant; and
a connection base configured to be fixed to a mounting surface and allow the container module to be installed on an upper surface of the connection base, wherein
the connection base includes:
a connecting mechanism configured to be connected to the instrument installed inside the container module;
a pipe arranged at a position below the upper surface, one end of the pipe connected to the connecting mechanism; and
a fixing mechanism configured to fix the container module.

9. The plant according to claim 8, wherein a plurality of the container modules include a tank module equipped with a tank configured to store hydrogen fuel and a dispenser module equipped with a dispenser configured to supply the hydrogen fuel to outside.

10. An installation method of installing a container module in which an instrument is installed in a plant including the container module and a connection base configured to be fixed to a mounting surface and allow the container module to be installed on an upper surface of the connection base, the connection base including, in advance, a connecting mechanism configured to be connected to the instrument installed inside the container module, a pipe arranged at a position below the upper surface, one end of the pipe connected to the connecting mechanism, and a fixing mechanism configured to fix the container module, the method comprising:
a placing step of placing the container module on the connection base;
a connecting step of connecting the container module to the connecting mechanism; and
a fixing step of fixing the container module to the connection base by the fixing mechanism.
